(19) United States
(12) Patent Application Publication
(10) Pub. No.: US 2006/0164747 A1
(43) Pub. Date: Jul. 27, 2006

(54) Method of determining format parameters of HDD

(75) Inventor: Yeong-kyun Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/336,924

(22) Filed: Jan. 23, 2006

(30) Foreign Application Priority Data
Jan. 24, 2005 (KR) 10-2005-0006338

(51) Int. Cl. G11B 19/02

(52) U.S. Cl. 360/69

(57) ABSTRACT

Provided is a format parameter determination method that enables the determination of optimal format parameters according to the characteristics of individual hard disc drives (HDDs) and the characteristics of heads. The method of determining format parameters of an HDD includes: measuring the characteristics of the HDD and heads; and determining the optimal format parameters according to the measured characteristics of the HDD and heads. Accordingly, by determining the optimal format parameters according to the characteristics of each HDD and each head, the performance of each HDD is improved.

### CROSS-REFERENCE TO RELATED APPLICATION

This application claims the benefit of Korean Patent Application No. 10-2005-0006338, filed on Jan. 24, 2005, in the Korean Intellectual Property Office, the disclosure of which is incorporated herein in its entirety by reference.

### BACKGROUND OF THE INVENTION

1. Field of the Invention

The present invention relates to a hard disc drive (HDD), and more particularly, to a format parameter determination method that enables the determination of the optimal format parameters according to the characteristics of individual HDDs and the characteristics of heads.

2. Description of the Related Art

A hard disc drive (HDD) is a device used for storing information. Typically, information is written on concentric tracks formed on the surface of a magnetic disc. The disc(s) are assembled together so that they can be rotated by a spindle motor, and information is accessed by a write/read unit, which is installed on an actuator arm rotated by a voice coil motor (VCM). The VCM is activated by a current in order to rotate the actuator arm and thus to move heads across the disc surface. Each write/read head reads information written on the disc surface by sensing changes of a magnetic field from the disc surface. A current is supplied to the heads to write information in tracks. The current generates the magnetic field, which magnetizes the disc surface.

Parameters which determine the format of the HDD (hereinafter, format parameters) include tracks per inch (TPI), which determines write density in a radial direction, bits per inch (BPI), which determines write density in a track direction or a recording frequency, a number of zones, a number of tracks per zone, and/or a number of sectors per track.

In the prior art, the format parameters of a HDD are determined when the HDD is designed. Accordingly, all the HDDs of the same product group (or model) have the same format parameters. However, since the features of the individual parts of each HDD and the features of the accomplished HDD are not reflected in the format, it is difficult for individual HDDs to show optimal performance.

For example, the distribution of a magnetic write widths (MWW) of heads, which are adapted to a model, is very wide, thus a single standard of TPI cannot be applied. A head having a wider MWW than a standard head, i.e. a head having an MWW corresponding to the standard TPI, can cause an adjacent track erase (ATE) problem, and on the other hand, a head having a narrower MWW than the standard head can cause a weak write problem. Here, the weak write indicates that the intensity of a recording magnetic field for writing data is weak, or data is written with a narrower width than the track width. This can cause failure at reproduction since the data cannot be correctly written or the intensity of a residual magnetic field is weak even if the data is written.

On the other hand, wide distribution of a data transmission rate according to heads or media cannot be dealt with using only single standard BPI (a standard indicating the data transmission rate). A head having a slower one than standard data transmission rate is unfit for accessing a system file or file allocation table (FAT) frequently used by an operating system, and an area representing a slower one than standard data transmission rate on a medium is unfit to store the system file or the FAT.

### SUMMARY OF THE INVENTION

Additional aspects and/or advantages of the invention will be set forth in part in the description which follows and, in part, will be apparent from the description, or may be learned by practice of the invention.

The present invention provides a method of determining format parameters according to the features of individual HDDs and heads. The present invention also provides a recording medium suitable for the method.

According to an aspect of the present invention, there is provided a method of determining format parameters of a hard disc drive (HDD), the method including: measuring the characteristics of the HDD and/or heads (during a manufacturing process); and determining the optimal format parameters according to the measured characteristics of the HDD and/or heads.

The method may further include: storing the optimal format parameters in a system area of the HDD; and reading and referring to the format parameters stored in the system area of the HDD when the HDD is booted.

The format parameters may include bits per inch (BPI), tracks per inch (TPI), a number of zones, a number of tracks per zone, a number of sectors per track for each zone, a sector pulse generation location for each zone, a data frequency for each zone, and a total number of sectors per zone.

According to another aspect of the present invention, there is provided a computer readable recording medium having recorded thereon a computer readable program for performing a method of determining format parameters of a hard disc drive (HDD), the method including: measuring the characteristics of the HDD and/or head(s); and determining the optimal format parameters according to the measured characteristics of the HDD and/or head(s).

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating MWW distribution of heads;

FIG. 2 is a flowchart illustrating a format parameter determination method according to an embodiment of the present invention;

FIG. 3 is a TPI-BER graph illustrating the trend of an error rate in response to changes of track width;

FIG. 4 is a chart illustrating numbers of tracks according to heads and zones;

FIG. 5 is a chart illustrating data transmission rate based on location on a disc;

FIG. 6 is a schematic plan view of an HDD to which an embodiment of the present invention is applied; and

FIG. 7 is a block diagram of a control unit for controlling the HDD shown in FIG. 6.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

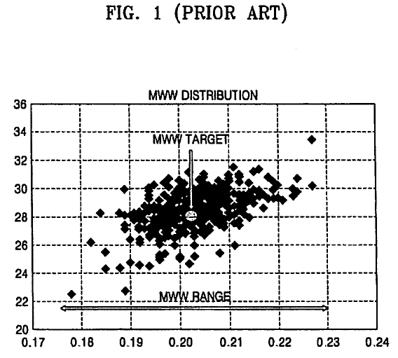

FIG. 1 is a graph illustrating magnetic write width (MWW) distribution of heads. The graph shows results obtained by measuring the MWWs of a plurality of heads using a Guzik Spinstand device. In FIG. 1, the horizontal axis indicates the MWW, and the vertical axis indicates overwrite capacity.

Referring to FIG. 1, the MWWs of the heads are distributed with a wide range over a standard MWW. Here, standard tracks per inch (TPI) is determined based on the standard MWW. In the prior art, the standard MWW is set in a product design stage, and all the HDDs of the same product group are formatted with the standard TPI.

Referring to FIG. 1, it can be seen that if the standard TPI corresponding to the standard MWW is applied uniformly to all heads, a head having a wider one than standard MWW can cause an adjacent track erase (ATE) problem, and on the other hand, a head having a narrower one than standard MWW can cause a weak write problem.

A data transmission rate varies according to a head and a location on a disc. A data transmission rate according to a head can vary according to the characteristics of a write/read channel circuit and the physical characteristics of the head, and a data transmission rate according to a location on a disc can vary according to a skew angle of a head, a linear velocity of a head and/or the physical characteristics of the disc.

Therefore, it can be seen that if format parameters according to a standard data transmission rate are applied uniformly to all the HDDs, a head having a slower than standard data transmission rate is unfit for accessing a system file or file allocation table (FAT) frequently used by an operating system, and an area representing a slower one than standard data transmission rate on a disc is unfit to store the system file or the FAT.

A format parameter determination method according to an embodiment of the present invention optimizes format parameters according to the characteristics of individual HDDs and heads, instead of uniformly applying the format parameters set in the product design stage to all the HDDs.

To do this, the characteristics of each model and head of the HDDs are measured, and the optimal format parameters are determined based on the measured characteristics. According to the format parameter determination method according to an embodiment of the present invention, since format parameters suitable for the characteristics of the model and heads of each HDD can be measured, the performance of each HDD is improved.

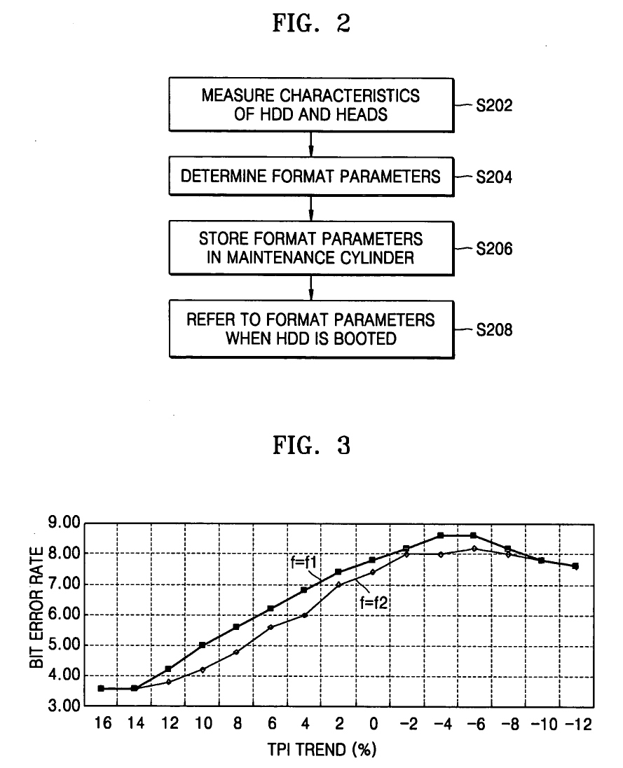

FIG. 2 is a flowchart illustrating the format parameter determination method according to an embodiment of the present invention.

The characteristics of each HDD and each head are measured in operation S202. For example, an ATW test is performed while changing a track width, and a TPI suitable for each head can be determined based on the results.

FIG. 3 is a TPI-BER graph illustrating the change of an error rate in response to changes of track width. FIG. 3 shows test results of two heads H1 and H2. In the ATW test, error rate is measured by a method in which test data is written on a target track and adjacent tracks and then test data written on a target track is reproduced. The TPI-BER curve shown in FIG. 3 is obtained by repeatedly performing the ATW test while changing the track width, i.e. the TPI. Here, the error rate is measured using a bit error rate (BER). The TPI corresponding to a criteria BER from the measured TPI-BER curve is determined as the TPI suitable for a corresponding head.

Format parameters suitable for the characteristics of each HDD and each head measured in a manufacturing process are determined in operation S204. The format parameters may include a table for converting servo tracks to data tracks, a number of sectors per track for each zone, a sector pulse generation location table for each zone, a data frequency synthesizing table for each zone, and/or a number of total sectors per zone.

Here, the table for converting servo tracks to data tracks, which is used for a self-servo writing, has a rate of reference servo tracks to final servo tracks. For example, if the rate is ¾, three reference servo tracks are converted to four final servo tracks in a servo copy process.

The data frequency synthesizing table is used for a data transmission rate. The data transmission rate is represented by a data transmission frequency, which can be obtained by synthesizing a plurality of basic frequencies. The data frequency synthesizing table has information of the basic frequencies required to realize a determined data transmission rate.

The format parameters, which are related to the TPI and BPI, are used to define a physical pattern of each HDD, i.e. to format each HDD.

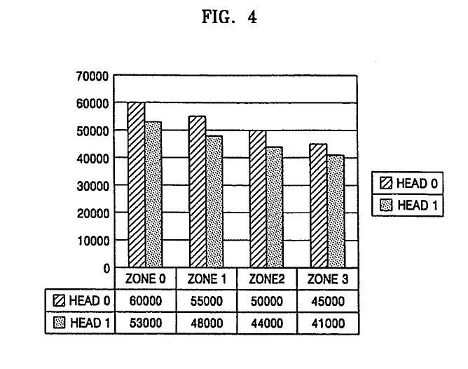

FIG. 4 is a chart illustrating numbers of tracks according to heads and zones. In FIG. 4, numbers of tracks per zone of two heads (head0 and head1) are different from each other. For example, for a zone 0, head 0 has 60,000 tracks, while head 1 has 53,000 tracks.

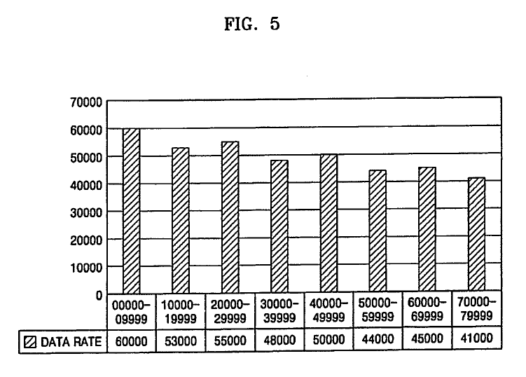

FIG. 5 is a chart illustrating data transmission rate based on location on a disc. In FIG. 5, the data transmission rate varies according to the location on the disc. For example, the data transmission rate for tracks 0-9,999 is 60,000 BPI, while the data transmission rate for tracks 10,000-19,999 is 53,000 BPI.

As described above, according to the format parameter determination method, the format parameters for determining the physical architecture of each HDD are optimized to fit each HDD based on the characteristics of each HDD and the characteristics of each head.

The characteristics of each HDD and head are measured during the manufacture of the HDDs, and the optimal format parameters are determined according to the results.

According to an aspect of the present invention, operations S202 and S204 are performed in the manufacturing process of the HDDs, i.e. a burn-in test process. Since the burn-in test process is performed after each HDD is assembled, it is suited to the measurement of the characteristics of each HDD and head.

The format parameters are stored in a system area of each corresponding HDD, e.g. a maintenance cylinder, in operation S206. Here, the maintenance cylinder is accessed by the HDD.

The format parameters written in the maintenance cylinder of each HDD are read and referred to whenever each HDD is booted, in operation S208.

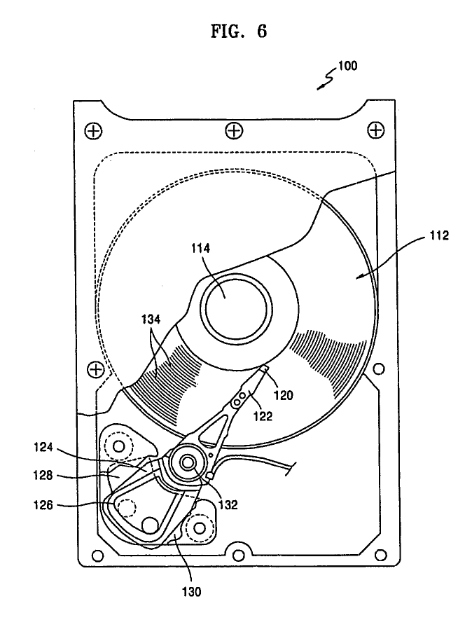

FIG. 6 is a schematic plan view of an HDD 100 to which an embodiment of the present invention is applied.

Referring to FIG. 6, the HDD 100 includes at least one disc 112 rotated by a spindle motor 114. The HDD 100 also includes a head 120 located adjacent to the surface of a disc 112.

The head 120 can read or write information from or to the rotating disc 112 by sensing a magnetic field formed on the disc 112 or magnetizing the disc 112. Though a single head 120 is shown in FIG. 6, the head 120 includes a write head, which magnetizes the disc 112, and a read head, which senses a magnetic field of the disc 112.

The head 120 generates an air bearing between itself and the surface of the disc 112. The head 120 is combined with a head stack assembly (HSA) 122. The HSA 122 is attached to an actuator arm 124 having a voice coil 126. The voice coil 126 is located adjacent to a magnetic assembly 128, which constitutes a voice coil motor (VCM) 130 together. A current supplied to the voice coil 126 generates a torque which rotates the actuator arm 124 around a bearing assembly 132. The rotation of the actuator arm 124 moves the head 120 across the surface of the disc 112.

Information is stored in concentric tracks on the disc 112. In general, the disc 112 includes a data zone in which user data is written, a parking zone in which the head 120 is located during the HDD 100 is not used, and a maintenance cylinder.

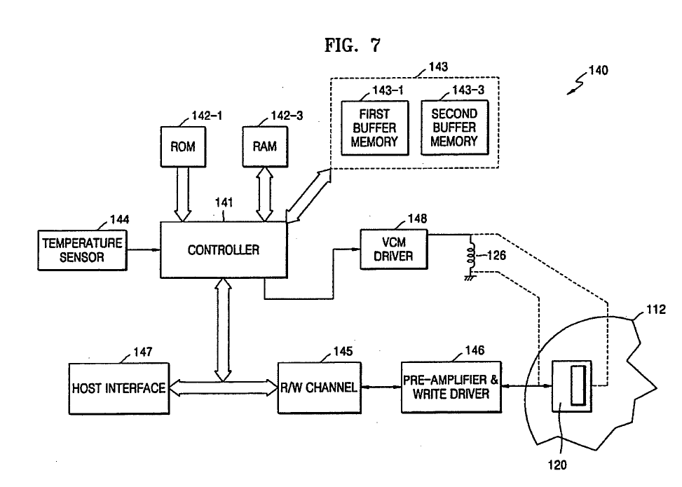

FIG. 7 is a block diagram of a control unit 140 for controlling the HDD 100 shown in FIG. 6.

The control unit 140 includes a controller 141 which is combined with the head 120 through a read/write (R/W) channel 145 and a read pre-amplifier & write driver 146. The controller 141 can be a digital signal processor (DSP), a microprocessor or a micro-controller.

The controller 141 provides a control signal to the R/W channel 145 to read data from the disc 112 or write data to the disc 112.

Information is typically transmitted from the R/W channel 145 to a host interface circuit 147. The host interface circuit 147 includes a control circuit allowing the HDD 100 to communicate with a system such as a personal computer.

The R/W channel 145 performs signal processing to convert an analog signal read from the head 120 in a reproduction mode and amplified by the read pre-amplifier 146 to a digital signal which can be read by a host computer (not shown), output the converted digital signal through the host interface circuit 147, receive user data from the host computer through the host interface circuit 147, convert the user data to a recording current to write the user data on the disc 112, and output the recording current to the write driver 146.

The controller 141 is combined with a VCM driver 148 that supplies a driving current to the voice coil 126. The controller 141 supplies a control signal to the VCM driver 148 to control the activation of a VCM and the motion of heads.

The controller 141 is connected to a nonvolatile memory, such as a read only memory (ROM) or a flash memory 142-1, and a random access memory (RAM) 142-3. The memory elements 142-1 and 142-3 store execution codes and data used by the controller 141 to execute software routines.

The software routines include a seek routine for moving a head from one track to another, and a following routine for following a target sector in a track. The seek routine includes a servo control routine for guaranteeing that the head is moved to an exact track.

Format parameters are stored in a maintenance cylinder (not shown) of the disc 112. The format parameters stored in the maintenance cylinder are read when the HDD 100 is booted. The controller 141 reads and refers to the format parameters stored in the maintenance cylinder when the HDD 100 is booted. In detail, the controller 141 sets a physical pattern of the HDD 100 by referring to a table for converting servo tracks to data tracks, a number of sectors per track for each zone, a sector pulse generation location table for each zone, a data frequency synthesizing table for each zone, and a total number of sectors per zone, which are read from the maintenance cylinder.

As described above, according to a method of determining format parameters of an HDD according to embodiments of the present invention, by determining the optimal format parameters according to the characteristics of each HDD and each head, the performance of each HDD is improved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of determining format parameters of a hard disc drive (HDD), the method comprising:
measuring the characteristics of the HDD and/or head(s); and
determining the optimal format parameters according to the measured characteristics of the HDD and/or head(s).

2. The method of claim 1, further comprising:
storing the optimal format parameters; and
reading and referring to the format parameters stored.

3. The method of claim 1, wherein the format parameters include bits per inch (BPI), tracks per inch (TPI), a number of zones, a number of tracks per zone, a number of sectors per track for each zone, a sector pulse generation location for each zone, a data frequency for each zone, and/or a total number of sectors per zone.

4. The method of claim 1, wherein the measuring the characteristics of the HDD and/or head(s) is during a manufacturing process.

5. The method of claim 2, wherein the optimal format parameter is in a system area of the HDD.

6. The method of claim 2, wherein the reading and referring to the format parameters when the HDD is booted.

7. A computer readable recording medium having recorded thereon a computer readable program for performing a method of determining format parameters of a hard disc drive (HDD), the method comprising:
measuring the characteristics of the HDD and/or head(s); and
determining the optimal format parameters according to the measured characteristics of the HDD and/or head(s).

8. The computer readable recording medium of claim 7, wherein the method further comprises:
storing the optimal format parameters; and
reading and referring to the format parameters stored.
